(19) United States
(12) Patent Application Publication
(10) Pub. No.: US 2011/0185739 A1
(43) Pub. Date: Aug. 4, 2011

(54) GAS TURBINE COMBUSTORS WITH DUAL WALLED LINERS

(75) Inventors: Thomas J. Bronson, Mesa, AZ (US); Nagaraja S. Rudrapatna, Chandler, AZ (US)

(73) Assignee: HONEYWELL INTERNATIONAL INC., Morristown, NJ (US)

(21) Appl. No.: 12/696,688

(22) Filed: Jan. 29, 2010

(51) Int. Cl. F02C 7/18

(52) U.S. Cl. 60/755; 60/752

(57) ABSTRACT

A combustor for a turbine engine includes a hot wall and a cold wall forming a dual walled liner and a liner cavity with the hot wall. The cold wall defines a plurality of impingement cooling holes configured to deliver an impingement cooling flow. A first downstream end terminates the hot wall and is configured to receive the impingement cooling flow from the plurality of impingement cooling holes, and a second downstream end terminates the cold wall and is longer in a generally downstream direction than the first downstream end. A combustion chamber is formed with the dual walled liner and the liner and faces an opposite side of the hot wall relative to the combustion chamber. The combustion chamber has a longitudinal axis and is configured to receive an air-fuel mixture in the generally downstream direction along the longitudinal axis.

### TECHNICAL FIELD

The present invention relates to gas turbine engines, and more particularly, to dual walled, gas turbine engine combustors.

### BACKGROUND

A gas turbine engine may be used to power various types of vehicles and systems. A particular type of gas turbine engine that may be used to power aircraft is a turbofan gas turbine engine. A turbofan gas turbine engine conventionally includes, for example, five major sections: a fan section, a compressor section, a combustor section, a turbine section, and an exhaust section.

The fan section is typically positioned at the inlet section of the engine and includes a fan that induces air from the surrounding environment into the engine and that accelerates a portion of this air towards the compressor section. The remaining portion of air induced into the fan section is accelerated into and through a bypass plenum and out the exhaust section. The compressor section raises the pressure of the air received from the fan section, and the compressed air then enters a combustion chamber of the combustor section, where a ring of fuel nozzles injects a steady stream of fuel. The fuel and air mixture is ignited to form combustion gases from which energy is extracted in the turbine section.

Known combustors include inner and outer liners that define the annular combustion chamber. Temperatures in the combustion chamber may be relatively high, including temperatures over 3500° F. Such high temperatures can adversely impact the service life of a combustor. Accordingly, some combustors are dual walled combustors in which the inner and outer liners each have so-called hot and cold walls that function to improve temperature performance. These arrangements may enable impingement-effusion cooling in which cooling air flows through the respective cold wall into cavities between the hot and cold walls to impinge on the hot wall. The cooling air then flows through angled effusion cooling holes in the hot wall to generate a cooling film on the inner surface of the hot wall to protect the liner from the elevated temperatures.

Although this type of cooling may be generally effective, it does suffer certain drawbacks. The cooling film, after it is sufficiently established, may be interrupted by any gaps, openings, or obstructions. As a result, some form of cooling augmentation may be used in particular sections of the combustor liners. Such cooling augmentation can complicate the construction of combustor and increase overall size, weight, and/or costs, particularly in a dual walled combustor. For example, additional walls and other components may experience different thermal growths and contraction relative to one another during operation. Moreover, additional walls require additional sealing arrangements and more complicated paths for the cooling air to reach the desired section. Additionally, some cooling augmentation techniques for dual walled combustors may cause installation and/or compatibility issues with, for example, the turbine section coupled downstream to the combustor.

Accordingly, it is desirable to provide for an impingement-effusion cooling configuration that exhibits improved film effectiveness at all sections of the combustor, particularly at the downstream ends of the combustor. Furthermore, other desirable features and characteristics of the present invention will become apparent from the subsequent detailed description of the invention and the appended claims, taken in conjunction with the accompanying drawings and this background of the invention.

### BRIEF SUMMARY

In one exemplary embodiment, a combustor for a turbine engine includes a hot wall and a cold wall forming a dual walled liner and a liner cavity with the hot wall. The cold wall defines a plurality of impingement cooling holes configured to deliver an impingement cooling flow. A first downstream end terminates the hot wall and is configured to receive the impingement cooling flow from the plurality of impingement cooling holes, and a second downstream end terminates the cold wall and is longer in a generally downstream direction than the first downstream end. A combustion chamber is formed with the dual walled liner and the liner and faces an opposite side of the hot wall relative to the combustion chamber. The combustion chamber has a longitudinal axis and is configured to receive an air-fuel mixture in the generally downstream direction along the longitudinal axis.

In another exemplary embodiment, a gas turbine engine combustor includes an inner liner having a first hot wall and a first cold wall that form an inner liner cavity. The first cold wall includes an outer side facing the inner liner cavity and an inner side opposite to the outer side. The first cold wall defines a first group of impingement holes configured to direct an impingement cooling flow onto the outer side of the first hot wall and the first hot wall defines effusion holes configured to generate an effusion cooling film on the inner side of the first hot wall. The first hot wall terminates with a downstream end that includes a lip that defines a gap with the first cold wall. The lip is configured to direct the effusion cooling film across the gap. The first cold wall defines a second group of impingement holes configured to direct the impingement cooling flow onto an inner surface of the first hot wall at the lip. An outer liner includes a second hot wall and a second cold wall that form an outer liner cavity. The inner liner is arranged with respect to the outer liner such that the first hot wall and the second hot wall at least partially define a combustion chamber therebetween.

### BRIEF DESCRIPTION OF THE DRAWINGS

The present invention will hereinafter be described in conjunction with the following drawing figures, wherein like numerals denote like elements, and wherein:

FIG. 1 is a simplified cross-sectional side view of an exemplary multi-spool turbofan gas turbine jet engine according to an exemplary embodiment;

FIG. 2 is a cross-sectional view of an exemplary combustor that may be used in the engine of FIG. 1;

FIG. 3 is a close-up view of a first portion of the combustor of FIG. 2;

FIG. 4 is a cross-sectional view of the first portion of the combustor of FIG. 3 through line 4-4 in accordance with an exemplary embodiment;

FIG. 5 is a cross-sectional view of the first portion of the combustor of FIG. 3 through line 4-4 in accordance with an alternate exemplary embodiment; and

FIG. 6 is a close-up view of a second portion of the combustor of FIG. 2.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Broadly, exemplary embodiments disclosed herein provide dual walled combustors with liners having hot and cold walls that incorporate impingement-effusion cooling. Each hot wall may terminate with a lip that encourages a smooth transition of cooling flow across a gap between the hot and cold walls as the cold wall transitions into the turbine section. The downstream end of the cold wall may have additional impingement cooling holes that direct cooling air onto the lip, and the cold wall may also include an end rail with slots that are clocked relative to the additional impingement cooling holes.

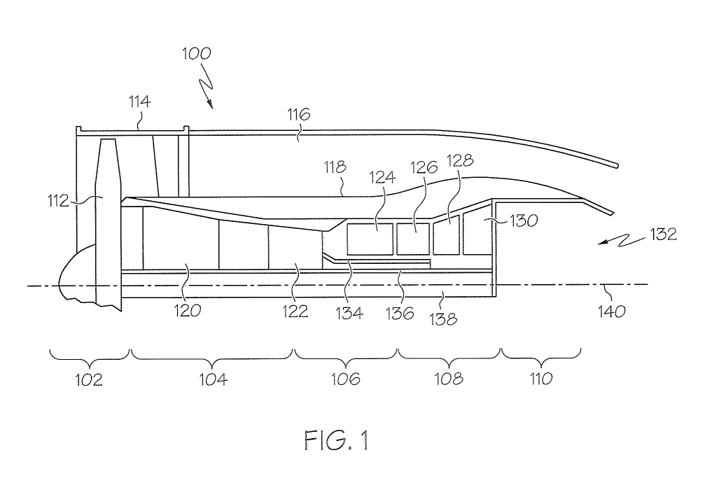

An exemplary embodiment of a multi-spool turbofan gas turbine jet engine 100 is depicted in FIG. 1, and includes an intake section 102, a compressor section 104, a combustion section 106, a turbine section 108, and an exhaust section 110. In general, the view of FIG. 1 shows half of the engine 100 with the rest rotationally extended about longitudinal axis 140. In addition to the depicted engine 100, exemplary embodiments discussed below may be incorporated into any type of engine and/or combustion section.

The intake section 102 includes a fan 112, which is mounted in a fan case 114. The fan 112 draws in and accelerates air into the intake section 102. A fraction of the accelerated air exhausted from the fan 112 is directed through a bypass section 116 disposed between the fan case 114 and an engine cowl 118. The remaining fraction of air exhausted from the fan 112 is directed into the compressor section 104.

The compressor section 104 includes an intermediate pressure compressor 120 and a high pressure compressor 122. The intermediate pressure compressor 120 raises the pressure of the air from the fan 112 and directs the compressed air into the high pressure compressor 122. The high pressure compressor 122 compresses the air further and directs the high pressure air into the combustion section 106. In the combustion section 106, the high pressure air is mixed with fuel and combusted in a combustor 124. The combusted air is then directed into the turbine section 108.

The turbine section 108 may have three turbines disposed in axial flow series, including a high pressure turbine 126, an intermediate pressure turbine 128, and a low pressure turbine 130. The combusted air from the combustion section 106 expands through each turbine, causing it to rotate. As the turbines rotate, each drives equipment in the engine 100 via concentrically disposed shafts or spools. Specifically, the high pressure turbine 126 drives the high pressure compressor 122 via a high pressure spool 134, the intermediate pressure turbine 128 drives the intermediate pressure compressor 120 via an intermediate pressure spool 136, and the low pressure turbine 130 drives the fan 112 via a low pressure spool 138. The air is then exhausted through a propulsion nozzle 132 disposed in the exhaust section 110.

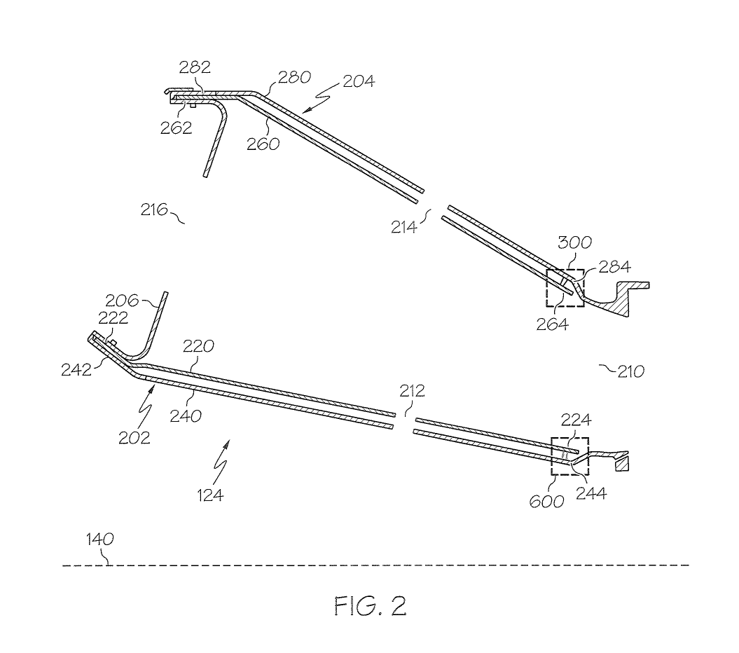

FIG. 2 is a cross-sectional view of an exemplary combustor, such as combustor 124, that may be used in the engine 100 of FIG. 1. As shown, the combustor 124 may be implemented as an annular combustor extending about longitudinal axis 140. The combustor 124 includes an inner liner 202, an outer liner 204, and a dome 206 that define a combustion chamber 208. The inner liner 202 is a dual walled liner with a hot wall 220 and a cold wall 240 with respective upstream ends 222, 242 and respective downstream ends 224, 244. The outer liner 204, which at least partially surrounds the inner liner 202, is also a dual walled liner that includes a hot wall 260 and a cold wall 280 with respective upstream ends 262, 282 and respective downstream ends 264, 284. As used herein, the term hot wall and cold wall refer to the relative position of the walls with respect to the combustion chamber.

Generally, the hot walls 220, 260 are formed by discrete sections or panels that closely adjoin one another to form the annular wall. As such, the hot walls 220, 260 may also be referred to as heat shields, heat panels, or heat tiles. The separation between the respective hot walls 220, 260 and the cold walls 240, 280 may be established by any spacing mechanism (not shown) as is known to those skilled in the art. Structures generally known as stand-offs may be provided at spaced intervals to establish a desired space between the hot walls 220, 260 and the cold walls 240, 280.

As noted above, the hot wall 220 of the inner liner 202 and the hot wall 260 of the outer liner 204 form the combustion chamber 208, and the downstream ends 244, 284 of the cold walls 240, 280 of the inner and outer liners 202, 204, respectively, form an opening 210 through which combusted air flows into the turbine section 108 (FIG. 1). As discussed in greater detail below, the hot walls 220, 260 terminate just upstream of the downstream ends 244, 284 of the cold walls 240, 280 such that the combustion chamber 208 mates with the turbine section 108 (FIG. 1) without requiring adapters or re-designs.

The inner liner 202 includes at least one circumferential row of dilution openings 212 that admit additional air through the cold wall 240 and hot wall 220 into the combustion chamber 208 to establish combustor aerodynamics and cool the exhaust gases to acceptable levels before entering the turbine section 108 (FIG. 1). Similarly, the outer liner 204 includes at least one row of dilution openings 214 that also admit additional air through the cold wall 280 and the hot wall 260 into the combustion chamber 208. In the depicted embodiment, one row of dilution openings 212, 214 is shown for each of the inner and outer liners 202, 204, although the combustor 124 may have two or more rows of dilution openings.

During operation, the dome 206 includes a number of circumferentially spaced, axially facing swirler assembly openings 216. Each of the swirler assembly openings 216 is configured to have mounted therein a swirler assembly (not shown) that mixes fuel and air, and the resulting mixture is then discharged into the combustion chamber 208 where it is ignited by one or more igniters (not shown) and provided to the turbine section 108 (FIG. 1) for energy extraction.

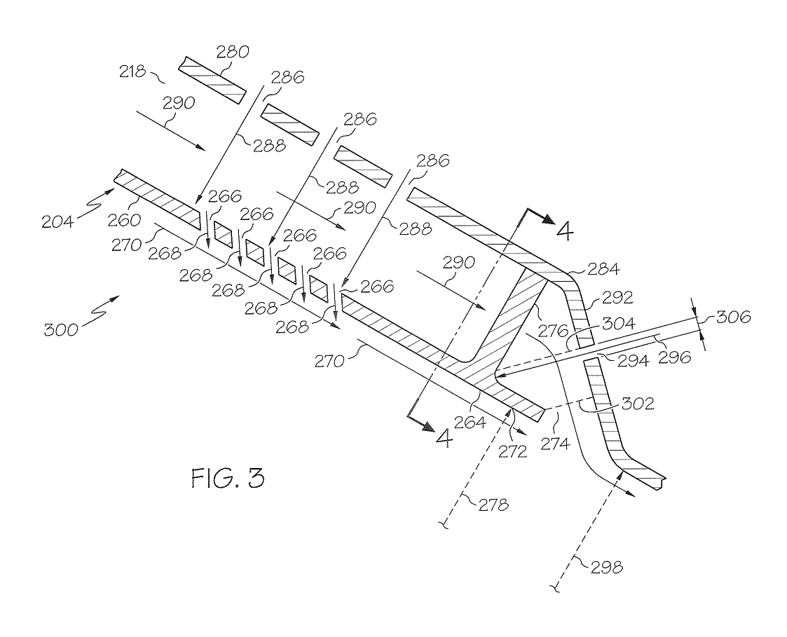

FIG. 3 is a close-up view of a first portion of an outer liner 204 of a combustor in accordance with an exemplary embodiment. In one exemplary embodiment, the view of FIG. 3 corresponds to portion 300 of the outer liner 204 of the combustor 124 of FIG. 2.

As best shown in FIG. 3, the outer liner 204 includes a plurality of impingement cooling holes 286 in the cold wall 280 and a plurality of effusion cooling holes 266 in the hot wall 260 to provide impingement-effusion cooling for the outer liner 204. As used herein, the term hole is not meant to be limited to a round aperture through a body as is illustrated in the embodiment depicted in the figures. Rather, the term hole is taken to mean any defined aperture through a body, including but not limited to a slit, a slot, a gap, a groove, and a scoop.

The impingement cooling holes 286 allow cooling air to flow through the cold wall 280, into a cavity 218 formed between the cold and hot walls 280, 260, and to the hot wall 260. Some of the cooling air through the impingement cooling holes 286 will flow essentially directly to the hot wall 260, as indicated by arrow 288, and the rest of the cooling air will be entrained in cooling air that flows downstream through the cavity 218, as indicated by arrow 290 (i.e., with cooling air from upstream impingement cooling holes). Generally, the impingement cooling holes 286 extend through the cold wall 280 at approximately 90°, although other angles may be provided.

The effusion cooling holes 266 in the hot wall 260 enable air flow from the cavity 218 and/or the impingement cooling holes 286 to cool the hot wall 260 via convective heat transfer as the cooling air passes through the effusion cooling holes 266, as indicated by arrows 268. Generally, the effusion cooling holes 266 extend through the hot wall 260 at approximately 15°-60°, although other angles may be provided. After the cooling air 268 passes through the effusion cooling holes 266, it becomes entrained in a cooling film 270 on the inner surface of the hot wall 260 that generally flows in a downstream direction. Establishing and maintaining the cooling film 270 along the inner surface of the hot wall 260 protects the hot wall 260 and other components from elevated temperatures.

The portion 300 of the outer liner 204 illustrated in FIG. 3 includes the downstream ends 264, 284 of the hot and cold walls 260, 280. The downstream ends 264, 284 are arranged to provide a smooth cooling film 270 as the combustor 124 mates with the turbine section 108 (FIG. 1). As also shown in FIG. 2, the hot wall 260 does not extend as far in the downstream or aft direction as the cold wall 280. In particular, the cold wall 280 has a transition section 292 that extends radially inward to the approximate dimensions of the inlet of the subsequent turbine section 108 (FIG. 1). As such, the cold wall 280 downstream of the transition section 292 is generally coplanar with respect to the downstream end 264 of the hot wall 260 in the view of FIG. 3. In other words, the cold wall 280 downstream of the transition section 292 has a radius 298 from the engine centerline or longitudinal axis (not shown) that is approximately equal to a radius 278 of the hot wall 260 at the downstream end 264.

This arrangement enables the use of the dual walled outer liner 204 without necessitating adapter apparatuses, even for engines with turbines that were originally designed for single-walled outer liners. In effect, exemplary embodiments of the dual walled outer liner 204 may be designed with the exit dimensions of a single walled outer liner, and as such, do not require extensive redesign, but also provide the cooling and performance benefits associated with dual walled liners.

The downstream end 264 of the hot wall 260 terminates with a lip 272 that defines a gap 274 between the hot and cold walls 260, 280. The downstream end 264 further includes a rail 276 that extends through the cavity 218 to the cold wall 280. The rail 276 and lip 272 cooperate with the transition section 292 of the cold wall 280 to ensure a smooth cooling film 270 across the gap 274 and into the turbine section 108 (FIG. 1). As discussed in greater detail below, the rail 276 includes openings that meter the cooling flow 290 exiting the cavity 218 into the cooling film 270. If too much or too little cooling flow 290 exits the cavity 218 at gap 274, the cooling film 270 may be interrupted, which may result in uneven or wasteful cooling or localized thermal issues. Similarly, the lip 272 functions to size the gap 274 to provide a sufficient exit for cooling flow 290 while not interrupting the continuous flow of the cooling film 270.

The transition section 292 of the cold wall 280 further defines one or more additional rows of impingement cooling holes 294 that direct a cooling flow 296 onto the lip 272. The transition impingement holes 294 may extend through the transition section 292 at an angle of approximately 90°. During operation, the cooling flow 296 may cool the lip 272 via convection and/or function to purge any hot gases residing in the gap 274. In one exemplary embodiment, the impingement cooling flow 296 strikes the lip 272 at the base of the rail 276, as shown, although other embodiments may direct the impingement cooling hole 296 in different areas. Additionally, although one row of transition impingement holes 294 is shown in FIG. 3, additionally rows may be provided. For example, a first row of transition impingement holes 294 may direct cooling flow 296 to the area in which the lip 272 meets the rail 276 and a second row of transition impingement holes 294 may direct cooling flow 296 further downstream of the rail 276 on the lip 272. This arrangement enables the lip 272 to maintain a desired temperature even while extending to any distance necessary for maintaining the smooth cooling film 270.

In one exemplary embodiment, a gap area to cooling area ratio can be specified. For example, the gap 274 may have a length 302 multiplied by the circumference of the annular liner 204 at the gap 274 (i.e., a gap area) that is approximately four times the collective area of the slots or openings in the rail 276 (discussed below) plus the collective area of the transition impingement holes 296 (i.e., the cooling flow area). In other embodiments, the ratio may be 3:1 or 5:1, or larger or smaller than these examples. The length 302 may be, for example, 0.045″-0.055″, although other lengths may be provided. Additionally, the distance 304 from the transition impingement holes 294 to the area to be cooled may be three to four times the diameter 306 of each transition impingement hole 294. Again, these ratios may be adjusted based on application or operating characteristics.

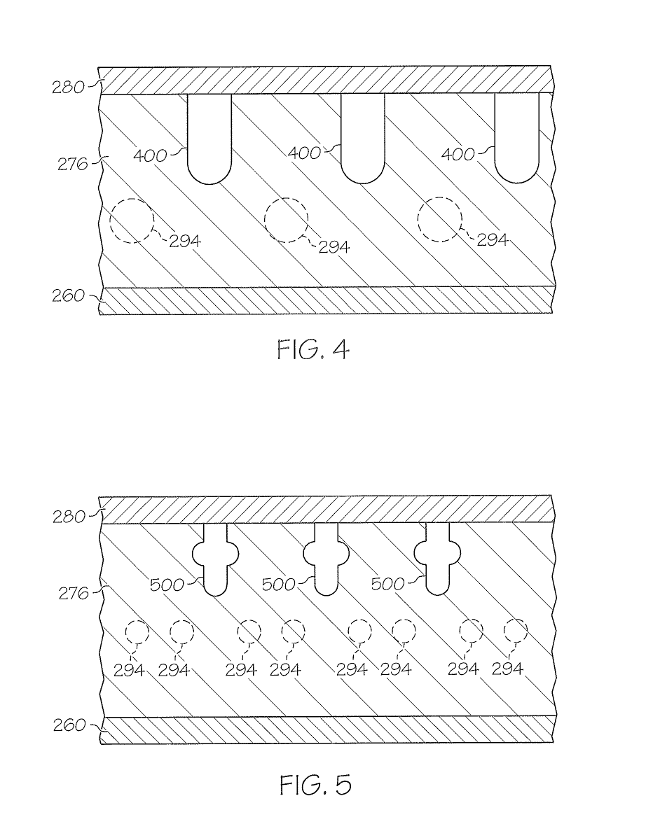

FIG. 4 is a cross-sectional view through line 4-4 of FIG. 3 and particularly shows a first exemplary embodiment of the rail 276 that extends between the hot wall 260 and the cold wall 280. As such, the discussion of FIG. 4 will also reference aspects of FIG. 3.

As noted above, the rail 276 defines slots or holes 400 that meter cooling flow 290 through the gap 274 and into the cooling film 270. The slots 400 may be evenly spaced along the rail 276 to accommodate the cooling flow 290. FIG. 4 also illustrates the approximate position of the transition impingement holes 294 relative to the slots 400. In one exemplary embodiment, the transition impingement holes 294 are offset from or otherwise clocked relative to the slots 400. Since the cooling flow 290 through the slots 400 provides some cooling for the lip 272, the transition impingement holes 294 may be specifically arranged to provide cooling flow 296 in other areas. This arrangement enables cooling of the lip 272, which is just downstream of the rail 276, with an efficient amount of cooling flow 296. In general, however, the transition impingement holes 294 may be arranged in any suitable pattern.

FIG. 5 is an alternate cross-sectional view through line 4-4 of FIG. 3 and particularly shows a second exemplary embodiment of the rail 276 that extends between the hot wall 260 and the cold wall 280. As such, the discussion of FIG. 5 will also reference aspects of FIG. 3.

In this exemplary embodiment, the rail 276 defines key-hole slots 500 that meter cooling flow 290 through the gap 274 and into the cooling film 270. As in FIG. 4, FIG. 5 illustrates the approximate position of the transition impingement holes 294 relative to the slots 500. In this exemplary embodiment, two transition impingement holes 294 are positioned between the slots 500 to cool the lip 272.

In further embodiments of the rail 276 discussed in FIGS. 4 and 5, other arrangements may be provided based on the temperature and operating characteristics of the engine 100 (FIG. 1). For example, three or more transition impingement holes 294 may be arranged between each slot 400, 500.

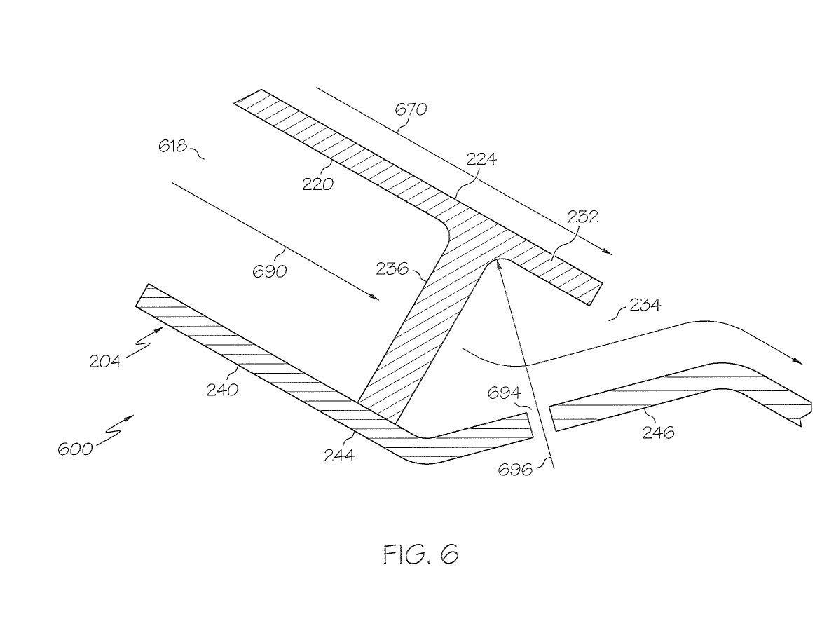

FIGS. 3-5 illustrate aspects of the outer liner 204. However, the configurations, dimensions, and ratios discussed above may also be incorporated into the inner liner 202. For example, FIG. 6 is a close-up view of the inner liner 202 that generally corresponds to portion 600 of FIG. 2 and illustrates the downstream ends 224, 244 of hot and cold walls 220, 240.

As above with respect to the outer liner 204, the hot and cold walls 220, 240 of the inner liner 202 define a cavity 618 through which cooling flow 690 flows. The cooling flow 690 may enter the cavity 618 through impingement cooling holes (not shown) in the cold wall 240 and function to cool the hot wall 220. The hot wall 220 may define a number of effusion cooling holes (not shown) through which cooling flow 690 flows to form a cooling film 670 on the inner surface of the hot wall 220.

The downstream ends 224, 244 of the hot and cold walls 220, 240 are arranged to provide a smooth cooling film 670 as the combustor 124 mates with the turbine section 108 (FIG. 1). As with the outer liner 204 (FIG. 3), the hot wall 220 of the inner liner 202 does not extend as far in the downstream or aft direction as the cold wall 240. In particular, the cold wall 240 has a transition portion 246 that extends radially inward to the approximate dimensions of the inlet of the subsequent turbine section 108 (FIG. 1). This arrangement enables the use of the dual walled outer liner 204 without necessitating adapter apparatuses, even for engines with turbines that were originally designed for single-walled outer liners. In effect, exemplary embodiments of the dual walled inner liner 202 may be designed with the exit dimensions of a single walled outer liner, and as such not require extensive redesign, but also provide the cooling and performance benefits associated with dual walled liners.

The downstream end 224 of the hot wall 220 terminates with a lip 232 that defines a gap 234 between the hot and cold walls 220, 240. The downstream end 264 further includes a rail 236 that extends through the cavity 618 to the cold wall 240. The rail 236 and lip 232 cooperate with the transition portion 246 of the cold wall 240 to ensure a smooth cooling film 670 across the gap 234 and into the turbine section 108 (FIG. 1). As above, the rail 236 includes openings that meter the cooling flow 690 exiting the cavity 618 into the cooling film 670.

The transition portion 246 of the cold wall 240 further defines one or more additional rows of impingement cooling holes 694 that direct a cooling flow 696 onto the lip 232. This arrangement enables the lip 232 to maintain a desired temperature even while extending to any distance necessary for maintaining the smooth cooling film 670. The transition impingement holes 694 may be arranged between the slots (not shown) in the rail 236 to provide cooling to desired areas of the lip 232. One, two, or more transition impingement holes 694 may be provided between each slot (not shown) in the rail 236. Similarly, one, two, or more rows of transition impingement holes 694 may be provided.

Accordingly, exemplary embodiments discussed herein provide enhanced cooling efficiency, and as such, improved performance. In particular, the lips 232, 272 of the hot walls 220, 260 enable a smooth transition of the effusion cooling film 670, 270 across any gaps 234, 274 between the respective hot walls 220, 260 and cold walls 240, 280. The transition impingement holes 694, 294 provide impingement cooling to protect the lips 232, 272 from any undesirable temperature conditions. Additionally, these arrangements provide an efficient cooling mechanism for a dual walled combustor that does not require cooling augmentation and/or adapters at the transition between the combustion section 106 and turbine section 108.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A combustor for a turbine engine, comprising:
a hot wall;
a cold wall forming a dual walled liner and a liner cavity with the hot wall, the cold wall defining a plurality of impingement cooling holes configured to deliver an impingement cooling flow;
a first downstream end terminating the hot wall that is configured to receive the impingement cooling flow from the plurality of impingement cooling holes;
a second downstream end terminating the cold wall that is longer in a generally downstream direction than the first downstream end;
a liner; and
a combustion chamber formed with the dual walled liner and the liner and facing an opposite side of the hot wall relative to the combustion chamber, the combustion chamber having a longitudinal axis and configured to receive an air-fuel mixture in the generally downstream direction along the longitudinal axis.

2. The combustor of claim 1, wherein the second downstream end defines the plurality of impingement cooling holes.

3. The combustor of claim 1, wherein the liner cavity is configured to receive a cavity cooling flow that flows through the liner cavity in the generally downstream direction, and
wherein the first downstream end of the hot wall and the second downstream end of the cold wall form a gap between the liner cavity and the combustion chamber such that the liner cavity cooling flow flows into the combustion chamber.

4. The combustor of claim 3, wherein the first downstream end comprises a rail that extends through the liner cavity to the cold wall, and
wherein the first downstream end further comprises a lip extending downstream of the rail to the gap, the plurality of impingement cooling holes configured to deliver the impingement cooling flow to the lip.

5. The combustor of claim 4, wherein the rail defines a plurality of slots configured to admit the liner cavity cooling flow into the gap.

6. The combustor of claim 5, wherein the plurality of impingement cooling holes are clocked with respect to the plurality of slots about the longitudinal axis.

7. The combustor of claim 6, wherein one of the plurality of impingement cooling holes is clocked between two adjacent slots.

8. The combustor of claim 6, wherein two of the plurality of impingement cooling holes are clocked between two adjacent slots.

9. The combustor of claim 1, wherein a first longitudinal end has a first radius relative to the longitudinal axis and the second downstream end has transition portion that extends from a second radius relative to the longitudinal axis to a third radius relative to the longitudinal axis, and wherein the third radius is approximately equal to the first radius.

10. The combustor of claim 9, wherein the plurality of impingement cooling holes are arranged within the transition portion of the second downstream end.

11. A gas turbine engine combustor, comprising:
an inner liner comprising a first hot wall and a first cold wall that form an inner liner cavity, the first cold wall having an outer side facing the inner liner cavity and an inner side opposite to the outer side,
wherein the first cold wall defines a first group of impingement holes configured to direct an impingement cooling flow onto the outer side of the first hot wall and the first hot wall defines effusion holes configured to generate an effusion cooling film on the inner side of the first hot wall,
wherein the first hot wall terminates with a downstream end that includes a lip that defines a gap with the first cold wall, the lip being configured to direct the effusion cooling film across the gap, and
wherein the first cold wall defines a second group of impingement holes configured to direct the impingement cooling flow onto an inner surface of the first hot wall at the lip; and
an outer liner comprising a second hot wall and a second cold wall that form an outer liner cavity, the inner liner being arranged with respect to the outer liner such that the first hot wall and the second hot wall at least partially define a combustion chamber therebetween.

12. The gas turbine engine combustor of claim 11, wherein the first hot wall further comprises a rail immediately upstream of the lip that extends through the inner liner cavity to the first cold wall.

13. The gas turbine engine combustor of claim 12, wherein the rail defines a plurality of slots configured to admit the impingement cooling flow into the gap.

14. The gas turbine engine combustor of claim 13, wherein the second group of impingement holes are clocked with respect to the plurality of slots.

15. The gas turbine engine combustor of claim 14, wherein one of the second group of impingement holes is clocked between two adjacent slots.

16. The gas turbine engine combustor of claim 14, wherein two of the second group of impingement holes are clocked between two adjacent slots.

17. The gas turbine engine combustor of claim 11, wherein the first cold wall has a first section generally upstream of the gap, a second section generally downstream of the gap, and a transition section that extends between the first section and the second section, and wherein the second section is generally coplanar with respect to the first hot wall.

18. The gas turbine engine combustor of claim 17, wherein the second group of impingement holes are formed in the transition section.

19. The gas turbine engine combustor of claim 11, wherein the second hot wall terminates with a second rail and a second lip immediately downstream of the second rail that defines a second gap with the second cold wall, and wherein the second cold wall defines a third group of impingement holes configured to direct the impingement cooling flow onto the second lip.

20. A gas turbine engine combustor, comprising:
an inner liner comprising a first hot wall and a first cold wall that form an inner liner cavity, the first cold wall having an outer side facing the inner liner cavity and an inner side opposite to the outer side,
wherein the first cold wall defines a first group of impingement holes configured to direct a first impingement cooling flow onto the outer side of the first hot wall, the first hot wall defining a first group of effusion holes configured to generate a first effusion cooling film on the inner side of the first hot wall,
wherein the first hot wall terminates with a first downstream end that includes a first lip that defines a first gap with the first cold wall, the first lip being configured to direct the first effusion cooling film across the first gap, and
wherein the first cold wall defines a second group of impingement holes configured to direct a second impingement cooling flow onto an inner surface of the first hot wall at the first lip; and
an outer liner comprising a second hot wall and a second cold wall that form an outer liner cavity, the inner liner being arranged with respect to the outer liner such that the first hot wall and the second hot wall at least partially define a combustion chamber therebetween,
wherein the second cold wall having an outer side facing the outer liner cavity and an inner side opposite to the outer side,
wherein the second cold wall defines a third group of impingement holes configured to direct a third impingement cooling flow onto the outer side of the second hot wall, the second hot wall defining a second group of effusion holes configured to generate a second effusion cooling film on the inner side of the second hot wall,
wherein the second hot wall terminates with a second downstream end that includes a second lip that defines a second gap with the second cold wall, the second lip being configured to direct the second effusion cooling film across the second gap, and
wherein the second cold wall defines a fourth group of impingement holes configured to direct a fourth impingement cooling flow onto the inner surface of the second hot wall at the second lip.
